(19) United States
(12) Patent Application Publication
(10) Pub. No.: US 2008/0126287 A1
(43) Pub. Date: May 29, 2008

(54) METHOD FOR MANAGEMENT OF POLICY CONFLICT IN A POLICY CONTINUUM

(75) Inventors: Gregory W. Cox, Schaumburg, IL (US); John C. Strassner, North Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/556,276

(22) Filed: Nov. 3, 2006

(51) Int. Cl. G06N 5/02

(52) U.S. Cl. 706/48

(57) ABSTRACT

A method (1300) for manipulation of two sets of policies is described, wherein each set includes at least two related policies, and wherein each policy comprises a set of policy rules. The method includes identifying (1325) a possible conflict between a pair of policies comprising one policy in each of two sets of policies, marking (1330) the one policy in each of the two sets of policies to identify the possible conflict, and marking (1330) at least one other policy in one of the two sets of policies that is related to one of the marked policies in the two policy rules to identify at least one other possible conflict.

### FIELD OF THE INVENTION

The present invention relates generally to policy-based information technology network and element management systems. More particularly, the present invention relates to management of policy conflict in groups of related policies.

### BACKGROUND

Policy-driven systems that are made up of many networked nodes are well known. Such systems could include wireless or wired communications infrastructure, as well as host systems, servers, mobile devices, and other resources whose access and availability is controlled using policy rules.

In complex systems, many different constituencies have different responsibilities in managing the system, and their differing interests may be reflected in a Policy Continuum as described in “Policy-Based Network Management: Solutions for the Next Generation” by John Strassner, copyright 2004 by Elsevier (hereafter referred to as Strassner PBNM) and shown in FIG. 1-8 on page 23 of Strassner PBNM. The policies tend to acquire increasing detail as they evolve from the business view to the instance view.

There are many reasons why policies can conflict. For example, management systems are typically custom applications made up of heterogeneous subsystems, and hence use different devices and applications with different languages. This gives rise to the following problems that usually require different solutions. First, differences in technologies used by devices as well as the management subsystems make it very difficult to ensure that commands having the same effect are being communicated to different devices having different languages and capabilities. Second, even if the network consists of devices manufactured by the same vendor, each device can support a multiplicity of software languages (e.g., CLI and SNMP). There are no standards for ensuring that commands in CLI correspond to monitored data in SNMP, and vice-versa; hence, a problem similar to the above arises.

A third problem is the separate evolution paths of policies (as defined by the different constituencies that they serve), due to the different roles and purposes that they serve. This also introduces the possibility that policies can conflict in more subtle ways. For example, a lower-level policy (e.g., an instance policy) could conflict with a higher-level policy (e.g., a business policy) because a direct translation between the two policies is not possible.

A fourth problem is that each of the views in the Policy Continuum defines its own unique terminology. Even if a language or set of languages were defined to relate a set of policies to each view, the fact that each view has its own terminology (and in this example, grammatical rules as well) means that the policies cannot communicate directly with each other.

These problems make conflicts between policies difficult to detect. In addition, policy may be a function of the state of the managed system. Further, detection of a conflict at one level of the Policy Continuum may imply conflicts between related policies at other levels of the Policy Continuum.

Many methods of policy conflict detection exist in the art However, these conventional methods address pair-wise policy conflict detection where each policy is defined using the same language and addresses the same constituency. Hence, the art does not address the four problems mentioned above. In other words, it does not contemplate implications of related policies in a Policy Continuum. As such, the art does not adequately address handling conflicts among sets of related policies.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate the embodiments and explain various principles and advantages, in accordance with the present invention.

FIG. 1 is a diagram that illustrates levels of policies in a Policy Continuum, in accordance with prior art and some embodiments of the invention.

FIGS. 2 and 3 are information models that illustrate some embodiments of methods for management of policy conflict propagation,

FIG. 4 is a diagram that illustrates policy relationships in a Policy Continuum, in accordance with some embodiments of the invention.

FIG. 5 is a diagram that illustrates possible conflict detection and marking in a Policy Continuum, in accordance with some embodiments of the invention.

FIG. 6 is a diagram that illustrates a search for actual policy conflict in a Policy Continuum, in accordance with some embodiments of the invention.

FIG. 7 is a flow chart that illustrates a method of actual policy conflict detection, in accordance with some embodiments of the invention.

FIG. 8 is a diagram that illustrates a progression of conflict resolution in a Policy Continuum, in accordance with some embodiments of the invention.

FIG. 9 is a flow chart that illustrates a method of policy conflict resolution, in accordance with some embodiments of the invention.

FIGS. 10 and 11 are a pseudocode listings of a policy rule, in accordance with some embodiments of the invention.

FIG. 12 is an information model that illustrate policy entities, in accordance with some embodiments of the invention.

FIG. 13 is a flow chart that illustrates a method of managing policy conflicts, in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to detecting a policy conflict or set of conflicts, relating said conflict or set of conflicts to the Policy Continuum, categorizing the nature of said conflict or conflicts (e.g., in the same or between different levels of the Policy Continuum, and which levels are involved), and communicating notice of said conflict(s) and category(ies) to other management applications. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. In this document objects may be referred to in the form in which they may be referred to when coded. Thus, “policy rule” may alternatively be written “PolicyRule”

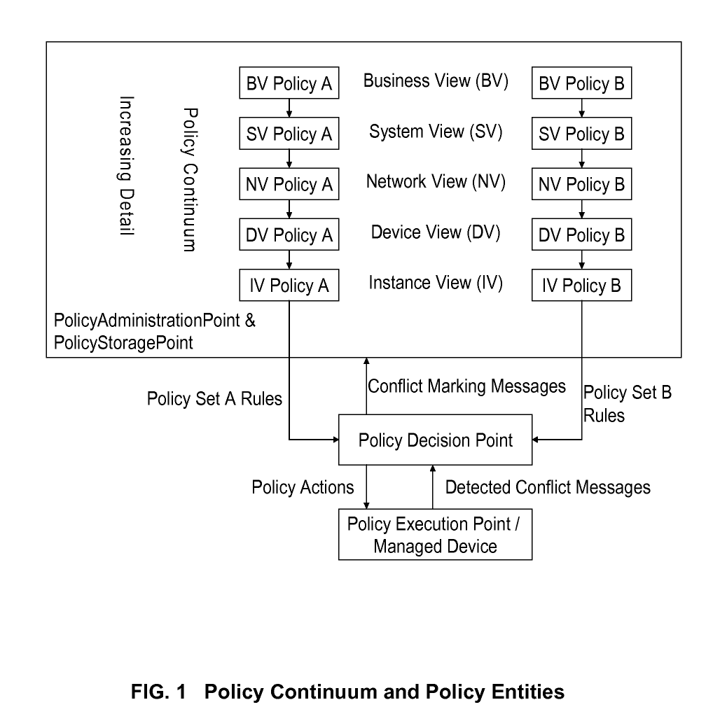

Referring to FIG. 1, an information model illustrates a Policy Continuum and certain aspects of policy conflicts, in accordance with embodiments of the present invention. As can be seen in FIG. 1, conflicts between policy rules in two sets of policies may be detected and marked, leading to efficient resolution of conflicts, as described in more detail below.

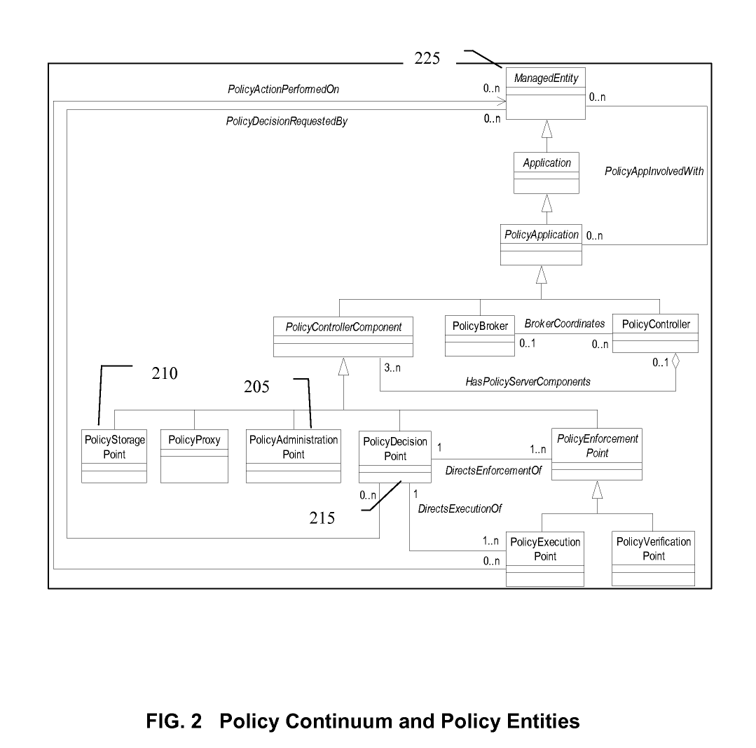

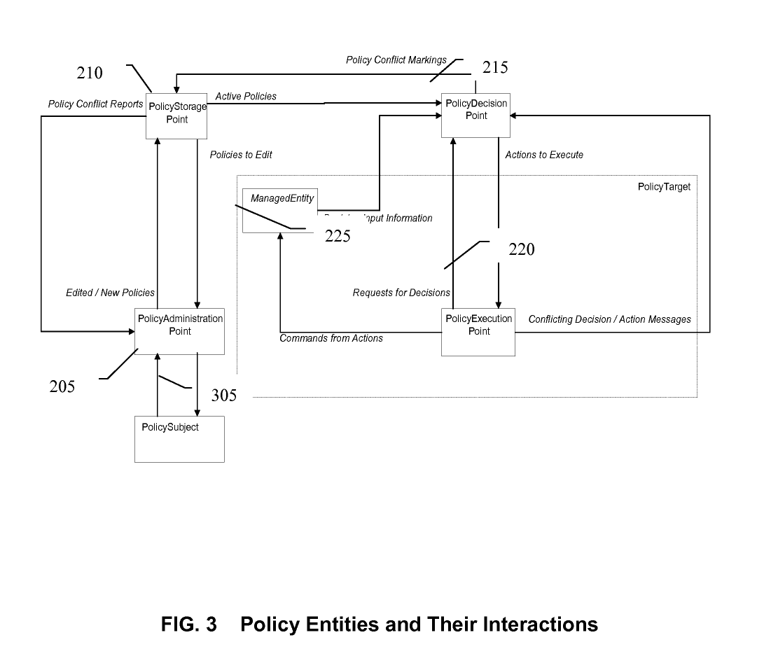

Referring to FIGS. 2 and 3, information models illustrate some embodiments of methods for management of policy conflict propagation, which may operate in a system of networked devices or within a processing device. The embodiments use a DEN-ng model (Directory Enabled Network—new generation), which comprises a PolicyAdministrationPoint 205 (FIG. 2), a PolicyStoragePoint 210, a PolicyDecisionPoint 215, and a PolicyExecutionPoint 220 that all work together to apply policies to one or more managed devices. In FIG. 2, an information model is shown that is an overview of a PolicyApplication Heirarchy is shown that includes the PolicyAdministrationPoint 205, the PolicyStoragePoint 210, the PolicyDecisionPoint 215, and the PolicyExecutionPoint 220. FIG. 3 is an information model that shows how these policy entities interact.

The PolicyAdministrationPoints 205 and PolicyStoragePoints 210 allow managers to enter, store, retrieve, and edit policies. Managers are one example of a PolicySubject 305 (FIG. 3). In addition, the PolicyAdministrationPoints 205 (FIG. 2) and PolicyStoragePoints 210 allow system managers to interact with entities in the managed system for purposes of monitoring policy execution and for resolving conflicts and other issues which may arise. The PolicyDecisionPoint 215 interprets policies sent from the PolicyAdministrationPoints 205 or retrieved from the PolicyStoragePoints 210, as well as requests from managed devices (signified as ManagedEntity 225 in FIGS. 2 and 3) for decisions from the PolicyDecisionPoint 215. The PolicyDecisionPoint 215 sends commands resulting from the evaluation of policies to the PolicyExecutionPoint 220, which is in charge of executing said policies. The PolicyExecutionPoint 220 can be on a device that communicates to managed entities that are PolicyTargets or embedded within a managed entity. The method for management of policy conflict propagation prescribed by the present invention runs on both the PolicyDecisionPoint 215 (FIGS. 2 and 3) as well as the PolicyExecutionPoint 220. The DEN-ng model of the embodiments described herein refines the PolicyExecutionPoint 220 used in simpler models into two additional entities—a PolicyExecutionPoint 220 and a PolicyVerificationPoint. The former is responsible for governing the execution of a prescribed set of actions on a set of managed entities; the latter observes how the set of managed entities that a policy was applied to behave, and provides status of that behavior. A PolicyProxy is used to translate between policy as understood by the policy engine and policy as understood by the managed entity. Finally, a PolicyBroker coordinates the actions of different policy engines, including helping to decide how to deal with policy conflicts. Other embodiments can use models other than the DEN-ng model; however, they must have the some of the same functionality as described in the DEN-ng model.

In some embodiments, a policy is equivalent to a collection of one or more policy rules. The following describes a general embodiment of a method of policy management which is modified to enhance the detection of different types of policy conflicts. Each policy rule comprises sets of events, conditions, and actions. A policy rule is activated when the event(s) specified by that rule occur. Events may include system alarms, system status parameters (e.g. link failure, power supply failure, appearance of new equipment, sign-on of a user, a specific instant in time or a specific amount of elapsed time, a named virtual event triggered by the action of another policy rule). Conditions test parameters against values. Conditions may be compound. Actions set parameters to values. Actions may be compound. Note that setting a parameter to a value may trigger complex actions such as the execution of a diagnostic algorithm, informing an operator or group of operators, activation or shutdown of equipment or programs, or even trigger the evaluation of another set of policies. Policy rules are further explained in section 1.3 starting on page 10 of [Strassner PBNM].

For purposes of the embodiments described herein, the term “policy” is equivalent to a single or a collected set of policy rules at a specific level of the Policy Continuum for a specific purpose. Note that a policy does not span multiple levels of the Policy Continuum. One of the strengths of these embodiments is to detect conflicts between multiple levels of the Policy Continuum—this means in practice that conflicts will be detected between multiple forms and representations of policies. For example, policy A in the business level of the Policy Continuum may have a grammar that is significantly different than policy B in another level (e.g., the system level) of the Policy Continuum.

Policy conflict has been defined as follows: (see page 162 of [Strassner PBMN]) A policy conflict occurs when the conditions of two or more policy rules that apply to the same set of managed objects are simultaneously satisfied, but the actions of two or more of these policy rules conflict with each other. As will be seen, certain embodiments described herein enhance this definition by using the terms PolicySubject and PolicyTarget to provide more specificity for the enhanced definition.

Each level in the Policy Continuum shown in FIG. 1 addresses a specific type of user that has a very specific understanding of the managed entities operating at that particular level of abstraction

The embodiments define two types of PolicyGroups—an IntraLevelPolicyGroup and an InterLevelPolicyGroup. The former groups policies at the same level in the Policy Continuum into a single containing object, or policy set; the latter groups policies at multiple levels in the Policy Continuum into containing object, or policy set.

To see the utility of the above, consider the following two examples. In a first example, a business policy set A may be an IntraLevelPolicyGroup at the business level of the Policy Continuum that represents the goal of a division in an organization and aggregates two different business policies B and C from two of its departments. The present invention can be used to find conflicts between these two business policies (B and C) to ensure the correctness of the business policy set A. A second example consists of a business policy set D that may be an IntraLevelPolicyGroup of the Policy Continuum that has 2 supporting system level policies, 5 network level policies, 20 device level policies, and 50 instance level policies. The present invention can be used to find conflicts between these different policies, even though they are specified at different levels of the Policy Continuum.

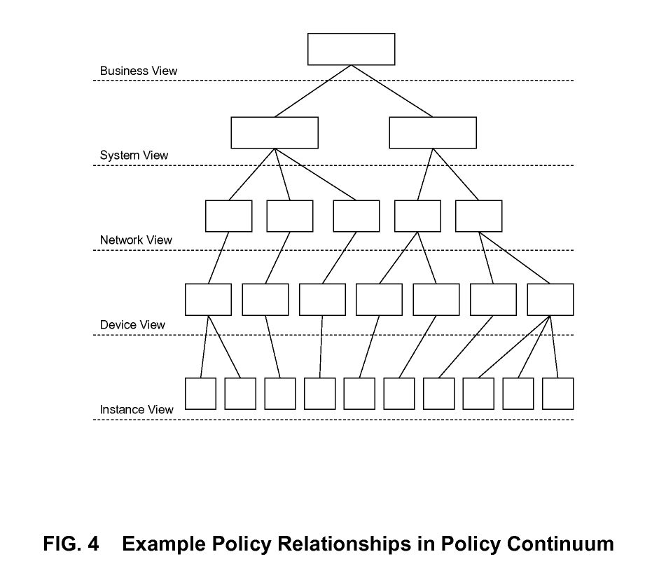

In both cases, the business policy set (A and D, respectively) defines one or more relationships between itself and other policies (e.g., a containment or a dependency relationship). These sets would typically have a tree structure as illustrated in FIG. 4, with the highest level policy (business is the highest, instance is the lowest) at the root of the tree. While it is easy to conceptualize this set of policies as related using a tree structure, said structure may or may not be hierarchical. In fact, as previously pointed out, less convenient structures usually occur. Policy sets having a tree structure will be used for simplicity and can be referred to as policy trees.

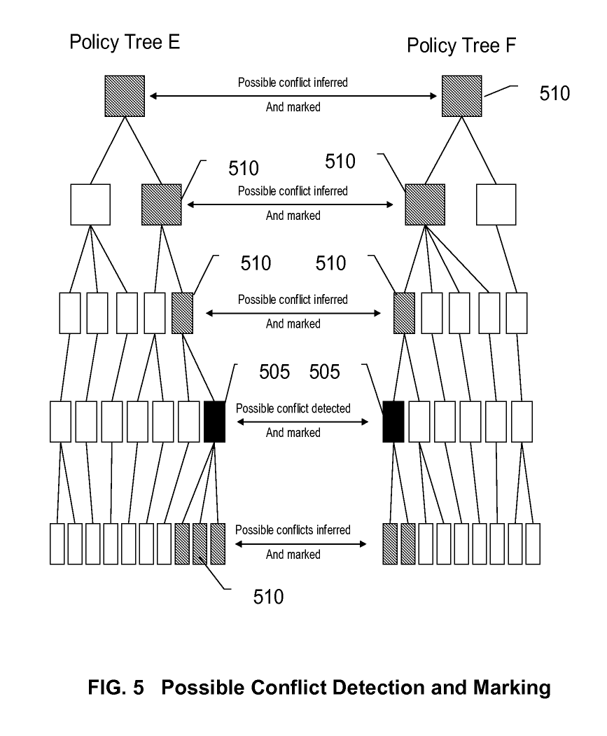

In some embodiments, when policy conflicts between policies of policy sets are to be found and corrected, the policies within each such policy set or policy tree should have been established as being non-conflicting within each policy set. If such is not the case, the methods of embodiments described herein may be used within any subsets of a policy set in which policies are not known to be non-conflicting. This possibility was described for the simple example of the IntraLevelPolicyGroup policy set A given above, and could be used with as few as two policies, although it would not be very efficient if used only for very small policy sets. A first step in some embodiments of the methods is to detect potential conflicts between policies of two such Policy Sets. When a potential conflict is detected, it is then tested to determine if it is a possible conflict. FIG. 5 shows an example wherein a possible conflict has been detected in a following step, between a policy of policy set E and a policy of policy set F that had been originally been determined to have a potential conflict, by methods described in more detail below. The possible conflict is depicted by the black rectangles 505. Although the example in FIG. 5 shows a possible conflict between polices at the same level of the Policy Continuum, it should be appreciated that a possible conflict can occur between policies of different levels of the Policy Continuum. A further step is to mark the two policies having a possible conflict and all policies related to each of the two policies that have been determined to have the possible conflict, as depicted by the grey rectangles 510 of FIG. 5. A policy is related to or derived from a policy at a higher level of the Policy Continuum when the policy expands on the definition, meaning or implementation of the policy at the next higher level. The marked, related policies other than the two policies originally detected to have the possible conflict are termed inferred possible conflicts.

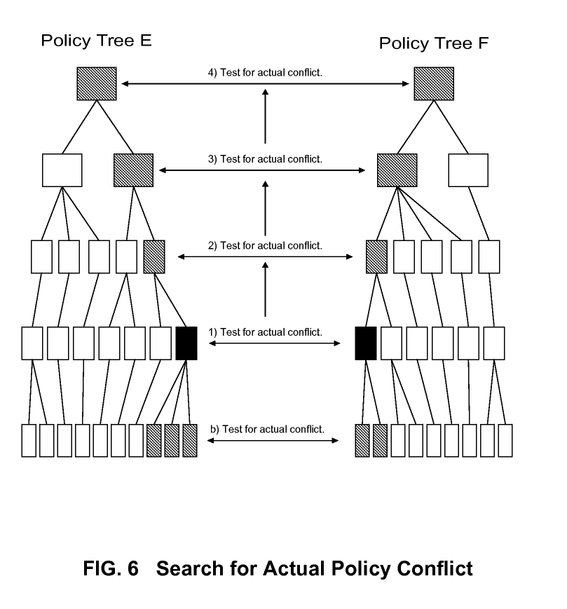

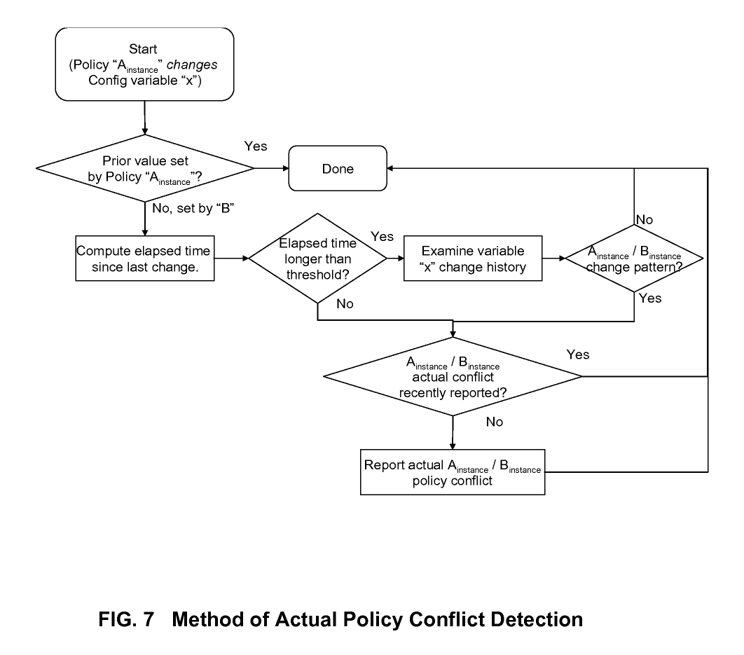

When a possible conflict is detected, a further step in some embodiments of the methods is to use the two marked possible policy conflicts as a starting point to perform an ordered search for actual policy conflict as illustrated in FIG. 6. An actual policy conflict is detected by methods such as the one shown in FIG. 7. Another method for actual policy conflict detection is to apply each of two policies under the same initial conditions of the network that are relevant to the two policies, and when different states result from the step of applying, identifying the two policies as actually conflicting. The search for actual policy conflict starts at the Policy Continuum level where possible policy conflict was detected, as shown in step 1 in FIG. 6. When an actual conflict is detected, then the method proceeds to check for actual conflict between marked policies of the two policy sets at the at the next higher Policy Continuum level. Checking for actual policy conflict continues at a next higher Policy Continuum level whenever an actual policy conflict is found at any level, up to and including the highest level. When no actual conflict is detected at step 2 or above, the method clears the marking of possible conflict at higher levels of the Policy Continuum and proceeds to step b. If no actual conflict is detected at step 1, then the method clears the marking of possible conflict at higher levels of the Policy Continuum and proceeds to step b to check lower level policies for actual conflict. When the checks for actual conflicts are completed and appropriate markings have been removed, a highest level of actual policy conflict has been identified. The actions described with reference to FIGS. 6 and 7 are performed by a PolicyExecutionPoint.

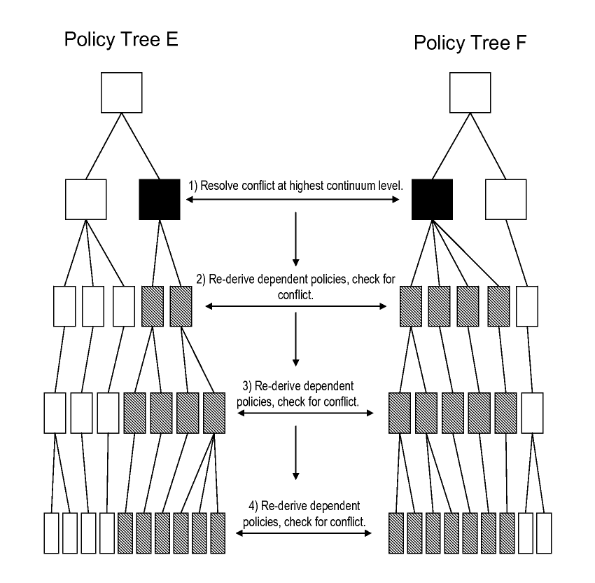

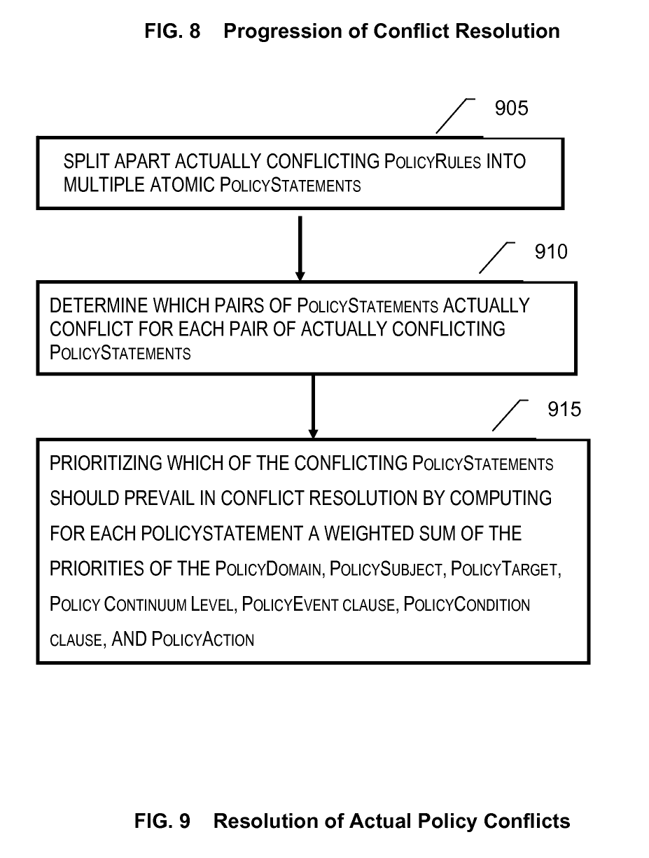

The method proceeds to perform a progression of policy conflict resolutions as illustrated in FIG. 8. The policy conflict resolutions start at the highest level of actual policy conflict identified. The policies derived from the policy at the highest level of actual conflict are marked as possibly requiring re-derivation. The highest-level policy conflict is resolved by automated or manual means by human intervention of the system manager. Once the highest-level actual policy conflict is resolved, dependent policies are re-derived if need be. When policies are re-derived, they are re-checked for actual policy conflict since re-deriving can produce new conflicts. If new conflicts are generated, then policy conflict resolution is invoked for the newly conflicting policies either by automated means or manual means by human intervention of the system manager. One automated method to facilitate resolution of actual policy conflicts, illustrated by a flow chart in FIG. 9, comprises splitting apart actually conflicting PolicyRules of two conflicting policies into multiple atomic PolicyStatements 905, determining which pairs of PolicyStatements actually conflict for each pair of actually conflicting PolicyStatements 910, and prioritizing which of the conflicting PolicyStatements should prevail in conflict resolution 915. More details related to these steps are given below. The prioritization 915 in some embodiments is done by computing for each PolicyStatement a weighted sum of the priorities of the PolicyDomain, PolicySubject, PolicyTarget, Policy Continuum Level, PolicyEvent clause, PolicyCondition clause, and PolicyAction wherein the weights reflect the relative importance of the PolicyDomain, PolicySubject, PolicyTarget, Policy Continuum Level, PolicyEvent clause, PolicyCondition clause, and PolicyAction. It will be appreciated that the weights for some of these may be zero. These steps may be following by automatically accepting the PolicyStatement with the highest weighted sum of priorities as a prevailing policy, or presenting some form of the information to a human for a decision. The information could be just the PolicyStatements of the rules of the two policies and the weighted sum for each, or more detail.

Note that it is advantageous to mark possible policy conflict since possible policy conflict detection requires fewer computational resources than the more exhaustive actual conflict detection. Further, policies marked as possibly conflicting may be regarded with different priority in a system or identified in a warning message to the system manager while actual conflict is being confirmed.

Putting the policy sets used in the above methods in the context of the DEN-ng information model, a PolicySet is the superclass of PolicyGroups and PolicyRules; the IntraLevelPolicyGroup and InterLevelPolicyGroup classes are subclasses of the PolicyGroup class. These embodiments also introduce three new constructs into the DEN-ng policy model: PolicyStatement, PolicySubject and PolicyTarget. The first construct causes Strassner's original PolicyStatement (i.e., the Policy Statement as described in Strassner PBNM) to be more correctly defined as a PolicyClause; the latter two augment Strassner's existing definition of policy conflict in order to discover more types of conflicts that apply across different levels of the Policy Continuum. This latter is significant, as the current art does not address this point.

The motivation for a PolicyStatement is to separate the different components of a PolicyRule in order to identify which conflict and which do not conflict. A PolicyStatement is a ManagedEntity that combines one or more PolicySubjects and one or more PolicyTargets into a separate, coherent managed entity so that the combination of PolicySubjects and PolicyTargets can be managed as an atomic group. PolicyRules can be subdivided into PolicyStatements, for example, with differing PolicyTargets associated with their PolicyActions. A PolicyStatement is said to be “atomic” when it cannot be further simplified or divided without violating the semantics of its PolicyRule(s). For example, PolicyStatements will often carry the full set of PolicyEvents from their PolicyRules since omitting PolicyEvents often changes important semantics of the aggregate PolicyRules. Put another way, a PolicyRule should be semantically equivalent to the collection of all of its constituent PolicyStatements.

Thus, a PolicyStatement may also be referred to an atomic PolicyStatement. This also facilitates defining reusable PolicyStatements that can be aggregated to form a PolicyRule. For the purpose of the embodiments, the definition of a PolicyStatement enables atomic declarations that could have conflicts to be separated so that the source of the conflict is properly identified. It also helps the overall system design, since PolicyStatements are intended to be reusable elements of a PolicyRule.

The motivation for PolicySubject is to separate out the set of objects upon which the PolicyStatement is predicated. A PolicySubject is defined as a set of ManagedEntities that is the focus of a Policy. The PolicySubject can make policy decision and information requests, it can assign Managed Entities to be PolicyTargets, and it can direct policies to be enforced at a set of PolicyTargets. Note that a PolicySubject does NOT evaluate PolicyRules, nor does it execute PolicyActions. Rather, it orchestrates the flow of policy evaluation. It is characterized as a managed object in order to build a set of reusable managed entities that can be used to form various PolicyStatements.

The motivation for a PolicyTarget is to separate out the set of ManagedEntities that describe actions that are to be applied by the PolicySubject. In other words, a PolicyTarget is a set of ManagedEntities that a set of policies will be applied to. As stated above, a PolicySubject has the ability to assign one or more ManagedEntities as a PolicyTarget. It is up to the PolicySubject to ensure that the selected PolicyTarget has the ability to process PolicyRules (which includes being able to receive events and/or messages that trigger the evaluation of the PolicyRule). Note that a PolicyProxy can provide a “translation function” between the commands received by the PolicyTarget and the actual ManagedEntity. The objective of applying PolicyRules is to either maintain the current state of the policy target (i.e. the current state is a “desired” state), or to transition the PolicyTarget to a new desired state. A PolicyTarget is characterized as a managed object in order to build a set of reusable managed entities that can be used to form various PolicyStatements.

Given the above definitions, the embodiments define a novel combination of methods to detect policy conflicts. The set of these methods is designed to minimize the computational complexity of discovering policy conflicts by isolating the different elements that make up a policy conflict. An important benefit of this approach is that it provides much greater precision in determining the source of the conflict; this increases the chance of (1) executing part of the policy, even if all of the policy couldn't be executed, and/or (2) finding a solution to solve the conflict. Oftentimes, a policy consists of a set of PolicyActions, not all of which depend on the same PolicyConditions. Hence, an advantage of this invention is that it determines which PolicyConditions depend on which PolicyActions, enabling part of the policy to be executed safely. Furthermore, the process of explicitly defining which PolicyActions can be safely executed and which cannot (because they are in conflict) enables a better understanding of the policy; the original policy can then be separated into a set of atomic policies that don't conflict, and/or a solution to the conflict has a better chance of being found. The art has not described either of these improvements, which is one reason why policy conflict detection has been computationally expensive and incomplete. The embodiments are amenable to parallelization and to being built in one or more apparatuses.

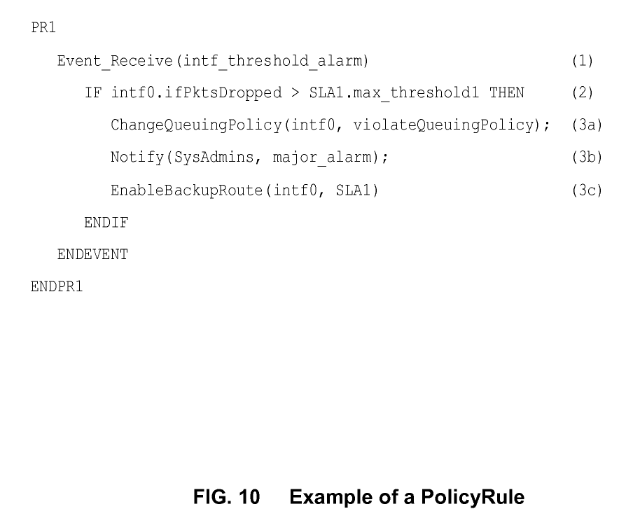

The embodiments concern PolicyRules, an example of which is shown as pseudocode listing in FIG. 10. This figure shows one PolicyRule (PR1) that has a single event (1), a single condition (2), and three actions (3a, 3b, and 3c).

The prior art in policy conflict detection attempts to evaluate this PolicyRule as a single, atomic action. This is suboptimal (or even wrong in some cases), as it does not consider that some of the actions (3a-3c of FIG. 10) might be in conflict independently, not the entire PolicyRule.

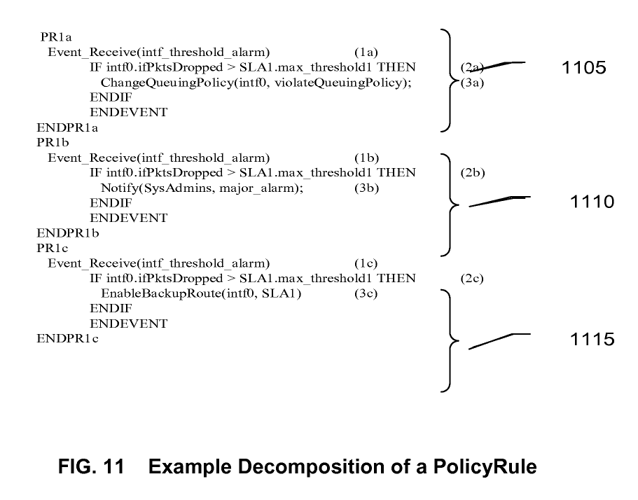

The issue is clarified by looking at a rewritten version of PR1, shown as a pseudocode listing in FIG. 11. In this version, we explicitly show the different PolicyStatements that make up the original PolicyRule PR1. This “denormalization” has the advantage of being able to identify the exact component of the PolicyRule that is in conflict.

FIG. 11 shows the translation of PR1 into 3 separate PolicyRules (PR1a 1105, PR1b 1110, and PR1c 1115) each of which has a single, atomic action. The advantage of this representation is that now, conflicts between the event and condition clauses of the PolicyRule and the different PolicyActions that the PolicyRule contains can now be explicitly represented. Furthermore, for each of the three PolicyRules PR1a, PR1b, and PR1c, we now can represent three distinct sets of PolicyEvent (e.g., 1a, 1b, 1c), PolicyCondition (e.g., 2a, 2b, 2c), and PolicyAction (e.g., 3a, 3b, 3c). (Note that this example could have been constructed to have multiple PolicyEvents and multiple PolicyConditions as well. Since this would only increase the difficulty of understanding the method, we have chosen not to do that.) However, the PolicySubject and PolicyTarget remain implicit. This requires a further modification of the format of the example PolicyRules.

The PolicySubject and PolicyTarget in PR1a, PR1b, and PR1c can be added by expanding the definition of a PolicyRule to explicitly include them as part of its definition. Hence, instead of defining a PolicyRule as a 3-tuple ({event-clause}, {condition-clause}, {action-clause}), some embodiments define a PolicyRule as a 5-tuple (PolicySubject, PolicyTarget, ({event-clause}, {condition-clause}, {action-clause})). This is shown in FIG. 6, which illustrates how a policy rule 605 devised using prior art techniques is formulated into a new policy rule 610 using techniques of the embodiments of the methods newly described herein.

Note that we have explicitly represented a PolicyRule as being made up of a single PolicySubject and a single PolicyTarget. The reason for this is rooted in how administration is currently performed for people and devices. Consider two PolicyRules, PRSA and PREU, authored by a System Administrator and an End User, respectively, that affect the same Policy Target but conflict with each other. Clearly, PRSA should be preferred over PREU, since the System Administrator is responsible for all users, not just the particular user PREU. By forcing our new PolicyRule to contain a single PolicySubject, we can easily detect and resolve this conflict.

Now, further suppose that two PolicyRules, PRC and PRD, apply to two different PolicyTargets. If these two PolicyRules conflict with each other, that means that two actions are doing at least two different things to two different ManagedEntities. Similarly, by forcing our new PolicyRule to contain a single PolicyTarget, we can now easily resolve conflicts by explicitly separating the PolicyTargets that the PolicyRule applies to.

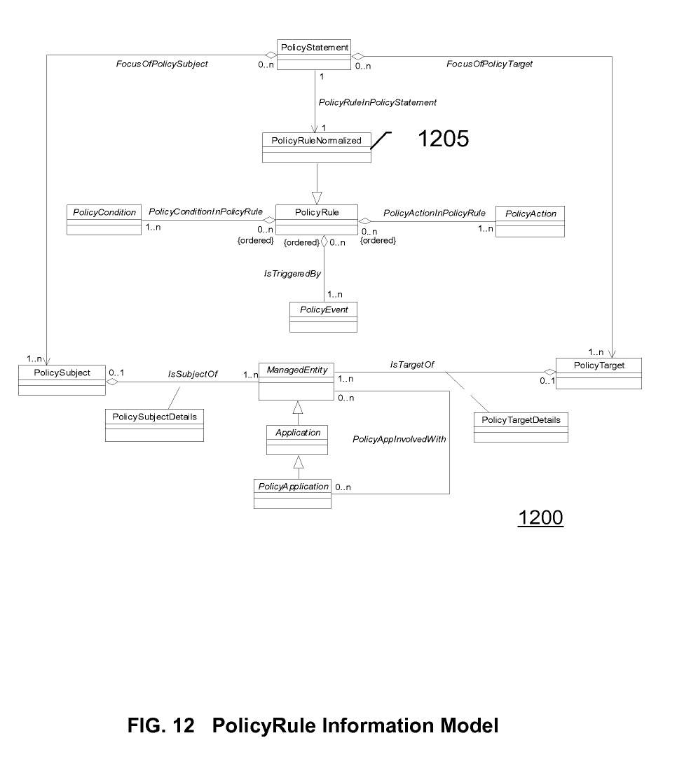

Now, with all five concepts (PolicySubject, PolicyTarget, PolicyEvent, PolicyCondition, and PolicyAction) separated and identified, a PolicyStatement can be defined as the union of these entities. This is shown by an information model 1200 in FIG. 12, which contains one new class that has not been discussed so far, called the PolicyRuleNormalized class 1205. This class represents a normalized view of a PolicyRule (as PR1a, PR1b, and PR1c collectively represented the normalized view of PR1 in the example above). Its purpose is to separate multiple PolicyEvents, PolicyConditions and PolicyActions into separate “normalized policy rules” that each have exactly ONE PolicyEvent, PolicyCondition, and PolicyAction. Note that this is exactly the form shown in FIG. 11—the three new PolicyRules PR1a, PR1b, and PR1c are now three instances of the PolicyRuleNormalized class. This is critical for proper policy conflict resolution. A PolicyRuleNormalized object is then related to a single PolicyStatement, which also combines the set of PolicySubjects and PolicyTargets that are involved.

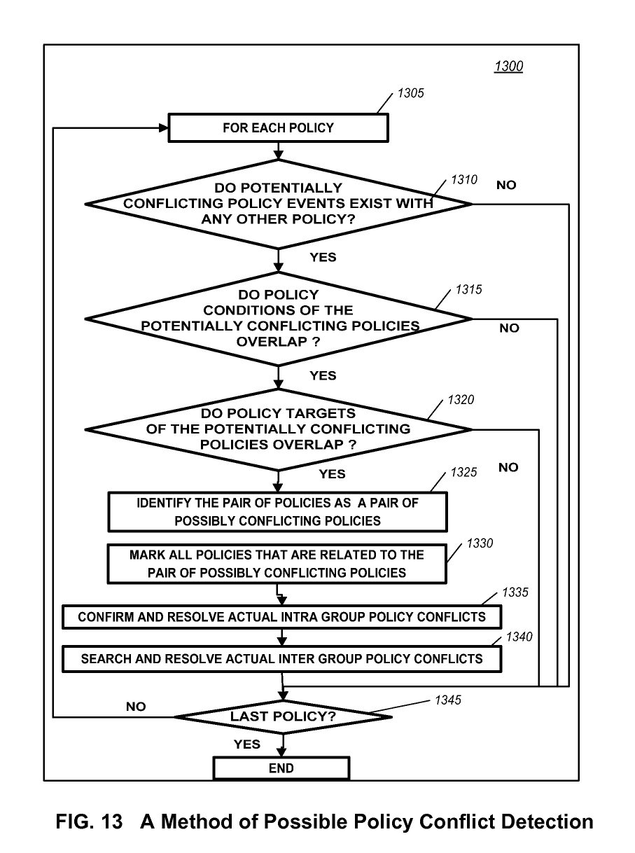

Given the above description, an embodiment of a method for managing policy conflicts exist is described with reference to FIG. 13, as follows. Each policy is tested for potential policy conflict against all other policies in the PolicyGroups of interest, as indicated by step 1305. A recommended first step 1310 for each policy, in order to detect policy conflicts, is to compare the overlap of PolicyEvents (i.e., does each Policy Event of the Policy Rule being compared occur according to the same metric or overlapping metrics of any Policy Event of the Policy Rule to which it is being compared). For example, if the metric of comparison used is time, then a potential conflict is flagged if two PolicyRules have the same PolicyTarget and the PolicyEvent portion of the PolicyStatement of one PolicyRule is equal to or a proper subset of the other PolicyRule. The rationale is that if the metric or metrics used do not overlap, then by definition there cannot be a conflict, because these actions are separated by the set of metrics used (e.g., business purpose or time).

The above step identifies potential conflicts. When a potential conflict is found between two PolicyRules, this potential conflict may be refined by next examining, at step 1315, if the PolicyConditions of the pair of PolicyRules overlap (i.e., apply to the same PolicyTarget). If they do not, the potential conflict is discarded; if they do, then the method continues to the next step.

A next step 1320 is to determine if the PolicyTargets of each of the pair of policies overlaps (i.e., different PolicyActions instruct the same PolicyTarget to do different things; note that a PolicyTarget can be a set of ManagedEntities, so this case usually examines if two different actions are being applied to the same ManagedEntity). If the PolicyTargets of each of the pair of policies overlaps, then all three conditions of steps 1310, 1315, 1320 are met, and the pair of policies are identified as a possible policy conflict at step 1325. If any one of the three conditions is not met, then there is no policy conflict, and the method goes to step 1345. Note that this method up through step 1325 decides whether a possible policy conflict exists in a computationally efficient manner.

The above process deals exclusively with PolicyRuleNormalized objects. An important benefit of this process is that it can not only determine if there is a policy conflict, it can determine what clause of the PolicyRule caused the policy conflict. For example, referring to FIG. 11, if we find that the action Notify(SysAdmins, major_alarm) could not be satisfied (in PolicyRuleNormalized PR1b), then instead of being limited to determining that PolicyRule PR1 failed, we can determine that the above action failed. This enables some (but possibly not all) implementations to derive benefit from being able to successfully execute PolicyRuleNormalized PR1a and PolicyRuleNormalized PR1c.

Once a possible conflict between a pair of policy rules is indentified as described above with reference to step 1325, a further step in an embodiment is to mark all policies in PolicyGroups associated with a policy that has been determined to be potentially conflicting by steps 1310-1320 as inferred, possibly conflicting policies, at step 1330, which was also described above with reference to FIG. 5. This is where the concepts of IntraLevelPolicyGroups and InterLevelPolicyGroups are then needed. IntraLevelPolicyGroups exist entirely within one level or view of the PolicyContinuum (e.g. a group of policies entirely within the System View). InterLevelPolicyGroups span at least two levels or views of the Policy Continuum (e.g. a group of policies spanning the Business, System and Network Views). The policy sets E, F illustrated in FIGS. 5, 6, and 8 are examples of two InterLevelPolicyGroups.

For IntraLevelPolicyGroups, a further step 1335 is to confirm and resolve actual conflicts among the other members of the IntraLevelPolicyGroups in which potential conflicts were detected. The method described above can thus be targeted toward a subset of all policies that are more likely to contain policy conflicts given the already detected policy conflict. In other words, policies within PolicyGroups already marked as having at least one possible conflict should have higher priority for conflict checking than policies that do not fall into such groups. Further, related policies with the same or overlapping PolicyConditions, PolicyEvents and/or PolicyActions can be given still higher priority in the policy conflict search than other policies within the PolicyGroups.

For InterLevelPolicyGroups, a further step is to search, detect and resolve actual policy conflicts at the highest Policy Continuum level of the IntraLevelPolicyGroups containing conflicting PolicyRules, at step 1340. Searching, detecting, and the progression of resolution of actual policy conflicts was described above with reference to FIGS. 6, 7, and 8. When policy conflicts are resolved at the highest level of the Policy Continuum, dependent policies in InterLevelPolicyGroups will be modified according to the negotiated policy conflict resolution and then re-checked for conflicts. Proceeding in this manner through the continuum increases the likelihood that conflict resolution can succeed in keeping with high-level directives for the managed system.

Sometimes, proceeding from the lowest level Policy Continuum level to the highest level is to be preferred in performing step 835. Such cases arise when the specification of particular actions are already known, but it is hard to author a high level (i.e., more abstract) version of this PolicyRule. It should be noted that this technique can be used in the embodiments described herein as well.

The above considerations necessitate another modification to the DEN-ng policy model. This change adds an object defining the level of the Policy Continuum that the PolicyRule is a part of. Hence, our final PolicyRule is defined as: (PolicySubject, PolicyTarget, Policy Continuum Level, PolicyEvent, PolicyCondition, and PolicyAction). The addition of Policy Continuum Level enables the identification of InterLevelPolicyGroups.

The final part of the DEN-ng policy model that will be used in policy conflict detection is the concept of a PolicyDomain. A PolicyDomain is a set of ManagedEntities that are administered in a coordinated fashion using the same set of PolicyRules by the same administrators. By including the parent PolicyDomain that a PolicyRule is defined in, conflict resolution can be accomplished by first separating PolicyRules into their respective PolicyDomains and subsequently using the semantics of the PolicyDomain to resolve conflicts. For example, one PolicyDomain may be considered to have more administrative rights than another PolicyDomain, and hence PolicyRules in the first PolicyDomain may override PolicyRules in the second PolicyDomain.

It will be appreciated that embodiments of the invention described herein may be comprised of one or more conventional processors and unique stored program instructions that control the one or more processors to implement, in conjunction with certain non-processor circuits, some, most, or all of the functions of the embodiments of the invention described herein. The non-processor circuits may include, but are not limited to, signal drivers, clock circuits, power source circuits, and user input/output devices. As such, these functions may be interpreted as steps of a method to perform policy conflict detection and resolution between different policy rules set in a Policy Continuum. Alternatively, some or all functions could be implemented by a state machine that has no stored program instructions, or in one or more application specific integrated circuits (ASICs), in which each function or some combinations of certain of the functions are implemented as custom logic. Of course, a combination of these approaches could be used. Thus, methods, apparatuses, and means for these functions have been described herein. In those situations for which functions of the embodiments can be implemented using a processor and stored program instructions, it will be appreciated that one means for implementing such functions is the media that stores the stored program instructions, be it magnetic storage or a signal conveying a file. Further, it is expected that one of ordinary skill, notwithstanding possibly significant effort and many design choices motivated by, for example, available time, current technology, and economic considerations, when guided by the concepts and principles disclosed herein will be readily capable of generating such stored program instructions and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for manipulation of two sets of policies, each set comprising at least two related policies, and wherein each policy comprises a set of policy rules, the method comprising:
identifying a possible conflict between a pair of policies comprising one policy in each of two sets of policies;
marking each policy of the pair of policies in each of the two sets of policies to identify the possible conflict; and
marking at least one other policy in one of the two sets of policies that is related to one of the pair of marked policies to identify an inferred possible conflict

2. The method according to claim 1, wherein identifying a possible conflict comprises identifying a possible conflict between two policies that are not necessarily at a same level of a Policy Continuum.

3. The method according to claim 1, wherein the marking of at least one other policy comprises marking all of the other policies related by policy derivation in each of the two sets of policies to mark inferred possible conflicts.

4. The method according to claim 1, further comprising marking all of the other related policies of each of the two sets of policies that are at higher or lower levels of the respective policy set.

5. The method according to claim 4 further comprising identifying a highest conflict level, which is a highest Policy Continuum level at which actual conflict occurs.

6. The method according to claim 4, further comprising detecting all policies, of those policies that have been marked in the step of marking a possible conflict and in the step of marking at least one other possible conflict, that actually conflict.

7. The method according to claim 6 wherein identifying all policies of each of the two sets of policies which actually conflict is accomplished by a method comprising:
applying each of two policies under the same initial conditions;
when different states result from the step of applying, identifying the two policies as actually conflicting.

8. The method according to claim 6, further comprising:
splitting apart actually conflicting PolicyRules into multiple atomic PolicyStatements;
determining which pairs of PolicyStatements actually conflict for each pair of actually conflicting PolicyStatements; and
prioritizing which of the conflicting PolicyStatements should prevail in conflict resolution by computing for each PolicyStatement a weighted sum of the priorities of the PolicyDomain, PolicySubject, PolicyTarget, Policy Continuum Level, PolicyEvent clause, PolicyCondition clause, and PolicyAction wherein the weights reflect the relative importance of the PolicyDomain, PolicySubject, PolicyTarget, Policy Continuum Level, PolicyEvent clause, PolicyCondition clause, and PolicyAction.

9. The method according to claim 6 wherein detecting all policies of the two sets of policies that have an actual conflict occurs on a PolicyExecutionPoint and wherein marking at least one other policy of each of the two sets of policies to identify a highest level of actual conflict occurs by the PolicyExecutionPoint.

10. A method for handling conflicts in two sets of policies, each set comprising at least two related policies, and wherein each policy comprises a set of policy rules, the method comprising:
splitting apart actually conflicting PolicyRules into multiple atomic PolicyStatements;
determining which pairs of PolicyStatements actually conflict for each pair of actually conflicting PolicyStatements; and
prioritizing which of the conflicting PolicyStatements should prevail in conflict resolution by computing for each PolicyStatement a weighted sum of the priorities of the PolicyDomain, PolicySubject, PolicyTarget, Policy Continuum Level, PolicyEvent clause, PolicyCondition clause, and PolicyAction wherein the weights reflect the relative importance of the PolicyDomain, PolicySubject, PolicyTarget, Policy Continuum Level, PolicyEvent clause, PolicyCondition clause, and PolicyAction.
